(19) United States
(12) Patent Application Publication
(10) Pub. No.: US 2010/0087137 A1
(43) Pub. Date: Apr. 8, 2010

(54) Vehicle safety system

(76) Inventors: John J. Fischer, Marietta, GA (US); Fred J. Wenz, Ft. Thomas, KY (US); Hap Nguyen, Westminister, CA (US)

Correspondence Address: LITMAN LAW OFFICES, LTD., POST OFFICE BOX 41200, SOUTH STATION, ARLINGTON, VA, 22204, US

(21) Appl. No.: 12/585,503

(22) Filed: Sep. 16, 2009

Related U.S. Application Data
(60) Provisional application No. 61/270,925, filed on Jul. 15, 2009.
(60) Provisional application No. 61/270,106, filed on Jul. 2, 2009.
(60) Provisional application No. 61/216,515, filed on May 17, 2009.
(60) Provisional application No. 61/215,976, filed on May 12, 2009.
(60) Provisional application No. 61/214,530, filed on Apr. 24, 2009.
(60) Provisional application No. 61/195,188, filed on Oct. 3, 2008.

(51) Int. Cl. H04K 3/00; H04B 7/00; G06F 17/00

(52) U.S. Cl. 455/1; 455/41.2; 701/45

(57) ABSTRACT

The vehicle safety system selectively deactivates a driver's cellular telephone when the driver is ready to drive his or her vehicle. The vehicle safety system first determines the proximity between the cellular telephone and the driver's seat of the vehicle. An identification tag is mounted on or in the vicinity of the driver's seat. The identification tag is sensed by a sensor to determine proximity. A gear state of the vehicle is then determined and transmitted to a call authorization module associated with the cellular telephone. The sensor for sensing the identification tag is also associated with the call authorization module. The call authorization module selectively deactivates the cellular telephone when the cellular telephone is located within a pre-set range from the driver's seat of the vehicle and the gear state of the vehicle is such that the vehicle may be driven under power.

### CROSS-REFERENCE TO RELATED APPLICATION

This application claims the benefit of U.S. Provisional Patent Application Ser. No. 61/270,925, filed Jul. 15, 2009; U.S. Provisional Patent Application Ser. No. 61/270,106, filed Jul. 2, 2009; U.S. Provisional Patent Application Ser. No. 61/216,515, filed May 17, 2009; U.S. Provisional Patent Application Ser. No. 61/215,976, filed May 12, 2009; U.S. Provisional Patent Application Ser. No. 61/214,530, filed Apr. 24, 2009; and U.S. Provisional Patent Application Ser. No. 61/195,188, filed Oct. 3, 2008.

### BACKGROUND OF THE INVENTION

1. Field of the Invention

The present invention relates to safety devices for automotive vehicles, and particularly to a vehicle safety system that disables a cellular telephone to prevent unsafe driving conditions.

2. Description of the Related Art

Over the past two decades, cellular telephones have gained widespread usage. It is estimated that over 280 million Americans own cellular telephones. Cellular telephones and applications for the telephones are evolving at a rapid pace. Portable computing devices are now being incorporated into cellular telephones which, though enabling greater work productivity, also bring with them increased hazards on the roadways.

In 2008, cellular telephones were directly responsible for 636,000 auto crashes, 330,000 overall injuries, 12,000 serious injuries and 2,600 deaths, with an estimated financial cost of 43 billion dollars. It is also believed that these statistics are vastly under-reported. Driver distraction caused by talking and/or text messaging on a cellular telephone while operating a motor vehicle has become a great hazard on the roadways, particularly for young and inexperienced drivers. Recent studies have shown that using a cellular telephone while driving is more dangerous than driving while legally intoxicated.

Although cellular telephones carry a great risk, they cannot simply be dispensed with, since emergency telephone calls and the like are often necessary, and carrying a cellular telephone in a vehicle may save one or more lives. Thus, a vehicle safety system solving the aforementioned problems is desired.

### SUMMARY OF THE INVENTION

The vehicle safety system selectively deactivates a driver's cellular telephone when the driver is ready to drive his or her vehicle. The vehicle safety system first determines the proximity between the cellular telephone and the driver's seat of the vehicle. An identification tag is mounted on, or in the vicinity of, the driver's seat. The identification tag is sensed by a sensor to determine proximity. A gear state of the vehicle is then determined and transmitted to a call authorization module associated with the cellular telephone. The sensor for sensing the identification tag is also associated with the call authorization module. For example, the identification tag may be a radio frequency identification (RFID) tag, and the sensor of the call authorization module may be a radio frequency sensor. The measured signal strength allows for determination of the proximity between the call authorization module (and the associated cellular telephone) and the driver's seat.

The call authorization module selectively deactivates the cellular telephone when the cellular telephone is located within a pre-set range from the driver's seat of the vehicle and the gear state of the vehicle is such that the vehicle may be driven under power. A position sensor may be mounted on or near the gearshift of the vehicle to determine the position of the gearshift and the gear state corresponding thereto. A transmitter is provided in communication with the position sensor to transmit the gearshift position to a receiver of the call authorization module.

Additionally, the call authorization module may first determine if the cellular telephone is presently in use or is about to be used to place a call. If so, the call authorization module then determines if an authorized call (such as an emergency call to 911, for example) is being placed. If an authorized call is being placed, an override signal is generated so that the cellular telephone remains in an activated state.

In an alternative embodiment, the vehicle is equipped with a transmitter for transmitting a cellular telephone jamming signal. A sensor system for determining the state of a driver's seatbelt of the vehicle is further provided. A controller is in communication with the engine so that the vehicle may be driven under power only upon detection of proper fastening of the driver's seatbelt, with the cellular telephone jamming signal being transmitted during actuation of the engine to prevent cellular telephone usage while driving. The sensor system includes at least one identification tag mounted on the driver's seatbelt and a sensor for determining proximity of the identification tag mounted in the vehicle's interior adjacent the driver's seatbelt.

These and other features of the present invention will become readily apparent upon further review of the following specification and drawings.

### BRIEF DESCRIPTION OF THE DRAWINGS

FIG. 1A is a block diagram providing an overview of the components of a first embodiment of a vehicle safety system according to the present invention.

FIG. 1B is a block diagram providing an overview of the components of an alternative embodiment of a vehicle safety system according to the present invention.

FIG. 2 is a flowchart showing steps in a method of using the vehicle safety system of FIG. 1A.

FIG. 3 is a flowchart showing the steps in an alternative embodiment of a method of using the vehicle safety system according to the present invention.

FIG. 4A is an environmental, perspective view of an alternative embodiment of a vehicle safety system according to the present invention.

FIG. 4B is an environmental, perspective view of the vehicle safety system of FIG. 4A, showing the system in use.

FIG. 5 is a flowchart showing the steps in another alternative embodiment of a method of using a vehicle safety system according to the present invention.

FIG. 6 is a block diagram showing the components of another alternative embodiment of a vehicle safety system according to the present invention.

Similar reference characters denote corresponding features consistently throughout the attached drawings.

### DETAILED DESCRIPTION OF THE PREFERRED EMBODIMENTS

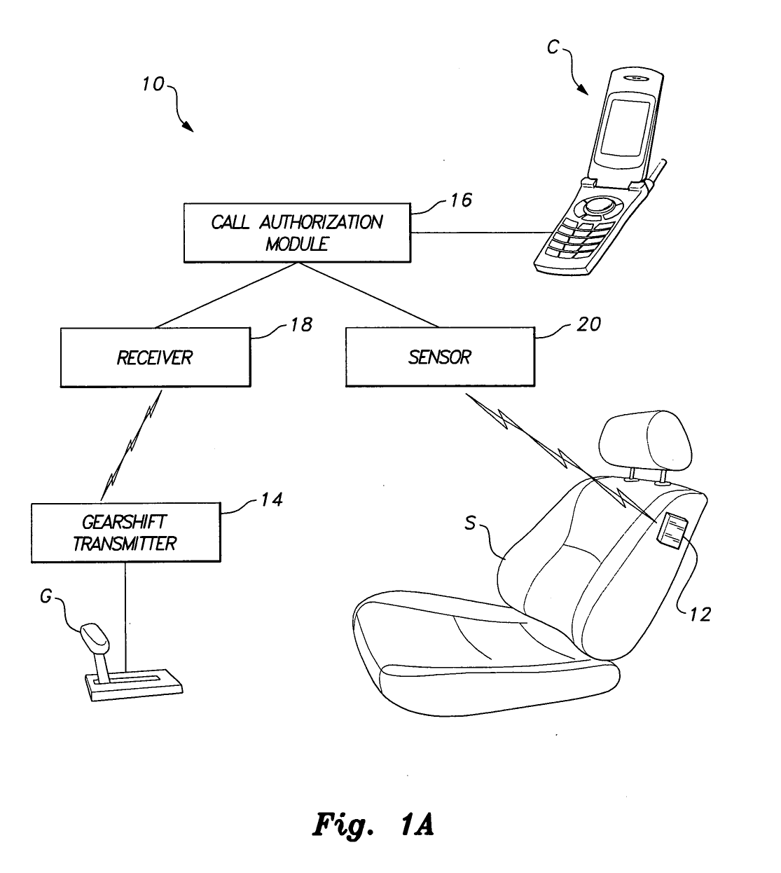

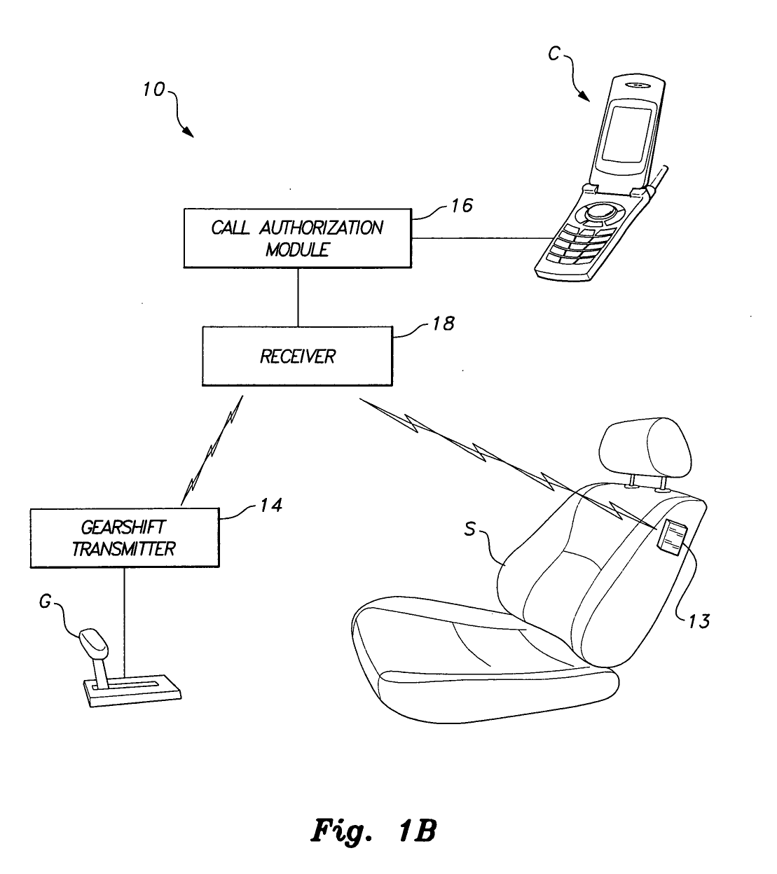

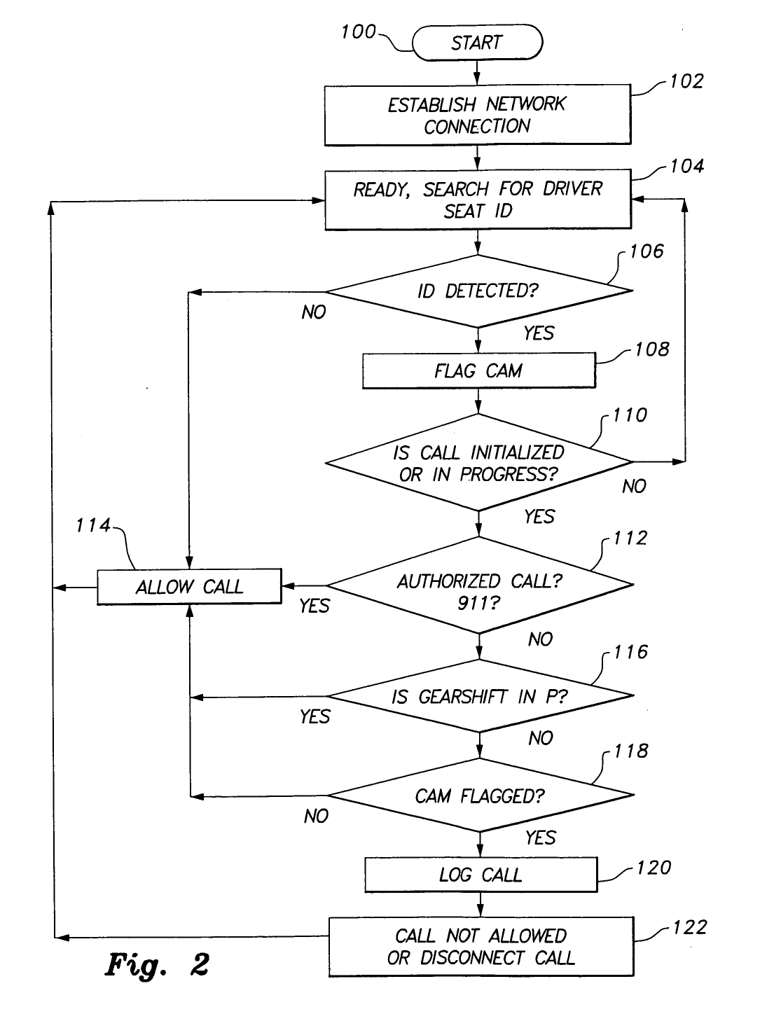

Referring to FIG. 1A, the components of a first embodiment of the vehicle safety system 10 are shown. The vehicle safety system 10 selectively deactivates a driver's cellular telephone C when the driver is ready to drive his or her vehicle. Upon actuation of system 10 (step 100 in FIG. 2) and initiation of cellular network connectivity (step 102), the vehicle safety system 10 determines the proximity between the cellular telephone C and the driver's seat S of the vehicle. An identification tag 12 is mounted on or in the vicinity of the driver's seat S. The identification tag 12 is sensed by a sensor 20 to determine proximity (step 104). If no signal is detected (or if the signal has a signal strength below a pre-set threshold), then a call from the cellular telephone C is allowed (step 114, with the determination of detection or proximity occurring in step 106).

A gear state of the vehicle (i.e., which gear the vehicle is in) is also determined and transmitted to a call authorization module 16 associated with the cellular telephone C. The sensor 20 for sensing the identification tag 12 is also associated with the call authorization module 16. For example, the identification tag 12 may be a radio frequency identification (RFID) tag, and the sensor 20 of the call authorization module 16 may be a radio frequency sensor. The measured signal strength allows for determination of the proximity between the call authorization module 16 (and the associated cellular telephone C) and the driver's seat S. It should be understood that any suitable type of identification tag or identifier may be utilized. In the alternative embodiment of FIG. 1B, tag 12 has been replaced by a low power, very short range transmitter 13, also integrated within the seat S. Thus, additional sensor 20 is not necessary in this embodiment, as the signal from transmitter 13 may be received by receiver 18 (to be described in greater detail below). Additionally, it should be understood that cellular telephone C is shown for exemplary purposes only, and that the systems of FIGS. 1A and 1B may be used with any desired portable device, such as a global positioning system (GPS) receiver, a notebook computer, a personal digital assistant (PDA) or the like.

The call authorization module 16 selectively deactivates the cellular telephone C when the cellular telephone C is located within a pre-set range from the driver's seat S of the vehicle and the gear state of the vehicle is such that the vehicle may be driven under power. The call authorization module 16 is preferably integrated into the circuitry of cellular telephone C, and may deactivate the cellular telephone C using any suitable process, such as disengaging or deactivating the antenna and/or transceiver of cellular telephone C. A position sensor may be mounted on or near the gearshift G of the vehicle to determine the position of the gear shift G and the gear state corresponding thereto. The detection of the gearshift position may utilize any suitable type of sensor, such as magnetic position sensors mounted within the gearshift housing or vehicle transmission. A transmitter 14 is provided in communication with the position sensor to transmit the gearshift position to a receiver 18 of the call authorization module 16. Transmitter 14 is preferably a wireless transmitter using any suitable type of wireless protocol, such as Bluetooth.

Additionally, the call authorization module 16 may first determine if the cellular telephone C is presently in use or is about to be used to place a call (step 110 in FIG. 2, with initiation of call authorization module 16 occurring at step 108). If so, the call authorization module (CAM) 16 then determines if an authorized call (such as an emergency call to 911) is being placed (step 112). If an authorized call is being placed, an override signal is generated (at step 114) so that the cellular telephone C remains in an activated state.

If an authorized call is not being placed and the gearshift is in a position indicating that the vehicle is about to be driven (for example, if the gearshift is not in “park” or neutral), then flow passes from step 116 to step 118, at which point the call authorization module 16 is activated to deactivate the cellular telephone at step 122. Additionally, the call attempt may be logged in memory associated with call authorization module 16 (step 120). It should be noted that the flagging of CAM 16 is necessary at both step 108 (i.e., the detection of the RFID signal) and step 118 (i.e., the determination of the gearshift position) in order to pass to step 122, the deactivation of cellular telephone C. It should be understood that such a system may be used in any environment, and that the vehicular example given above is a single, exemplary implementation of the system. For example, a similar system, with the gearshift being replaced any condition specific to the environment, may be utilized in classrooms, hospitals or any other environment in which cellular telephone use is sought to be discouraged.

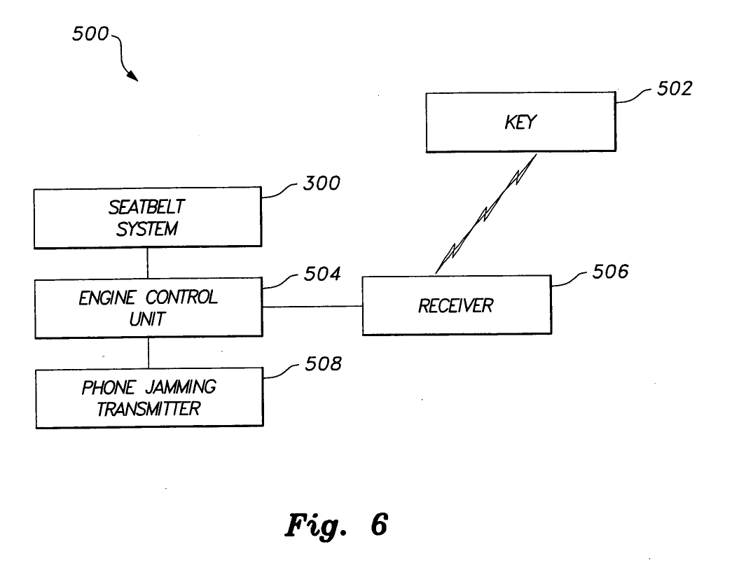

In the alternative embodiment of FIG. 6, the vehicle is equipped with a transmitter 508 for transmitting a cellular telephone jamming signal. In system 500, a sensor system 300 for determining a state of a driver's seatbelt 310 (i.e., whether the seatbelt is buckled) of the vehicle is further provided. A controller 504 is in communication with the engine of the vehicle so that the vehicle may be driven under power only upon detection of proper fastening of the driver's seatbelt 310, with the cellular telephone jamming signal being transmitted during actuation of the engine to prevent cellular telephone use while driving. Additionally, an identification tag, such as an RFID tag or the like, may be embedded in the ignition key 502 so that the engine may only be activated upon reception of an authorized identification signal, received by a receiver 506, which is in communication with controller 504. The cellular telephone jamming signal may be any signal suitable for jamming reception and transmission of the cellular telephone signals, or may be a specific deactivation signal that is transmitted wirelessly to a module, such as CAM 16 of FIG. 1A, which causes the cellular telephone to deactivate. It should be understood that such a signal may be universal and not cellular telephone specific, allowing any cellular telephone within the pre-determined vicinity to become selectively deactuated.

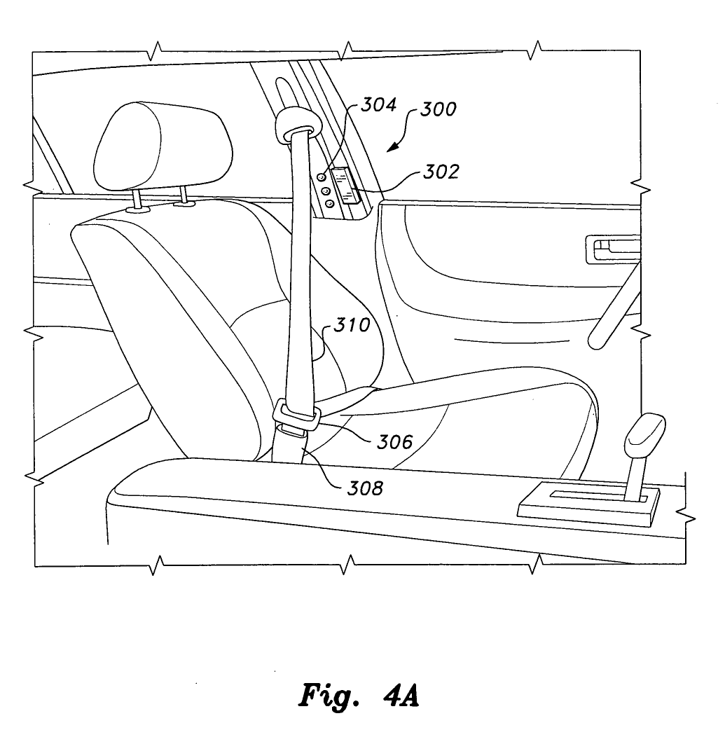

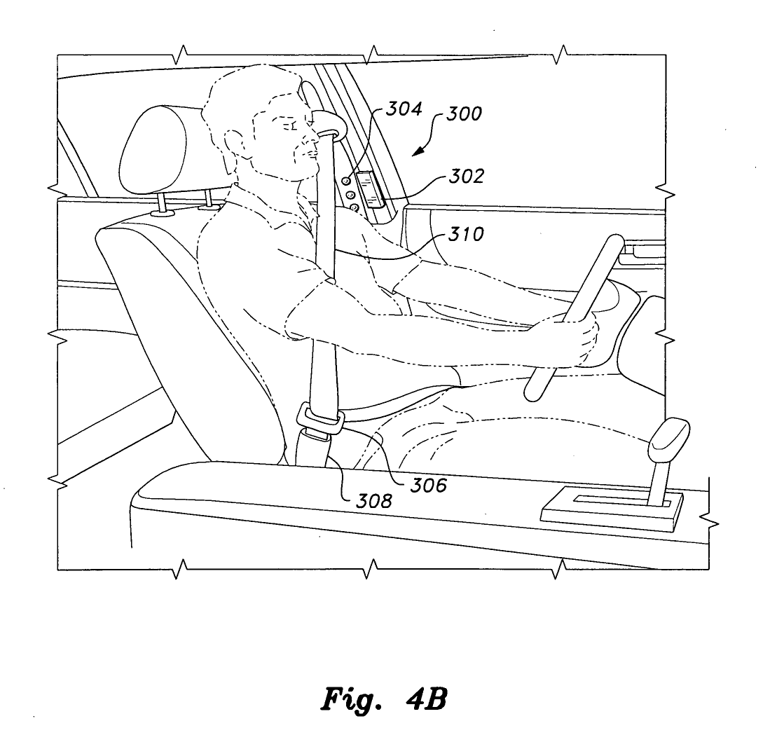

FIGS. 4A and 4B illustrate the seatbelt sensor system 300. As shown, system 300 includes at least one identification tag 304 mounted on the driver's seatbelt 310 and a sensor 302 for determining proximity of the identification tag 304 mounted in the vehicle's interior adjacent the driver's seatbelt 310. The identification tag 304 may be an RFID tag, a magnet or the like. Sensor 302 may be a radio frequency sensor, a magnetic sensor or the like.

In FIG. 4A, the seatbelt 310 is shown with male locking member 306 being received by female locking receptacle 308 (as is conventionally known in seatbelts), but without the driver in the driver's seat. In this position, the identification tag(s) 304 are in close proximity to the sensor 302. When close proximity is measured, the controller 504 will not allow the engine of the vehicle to start. In FIG. 4B, with the driver in the driver's seat, the seatbelt 310 is stretched, moving the identification tag(s) 304 away from sensor 302. When this pre-set distance between the tag(s) 304 and sensor 302 is detected or determined, the engine control unit 504 allows the engine to start (and also actuates the cellular telephone jamming signal transmitter 508).

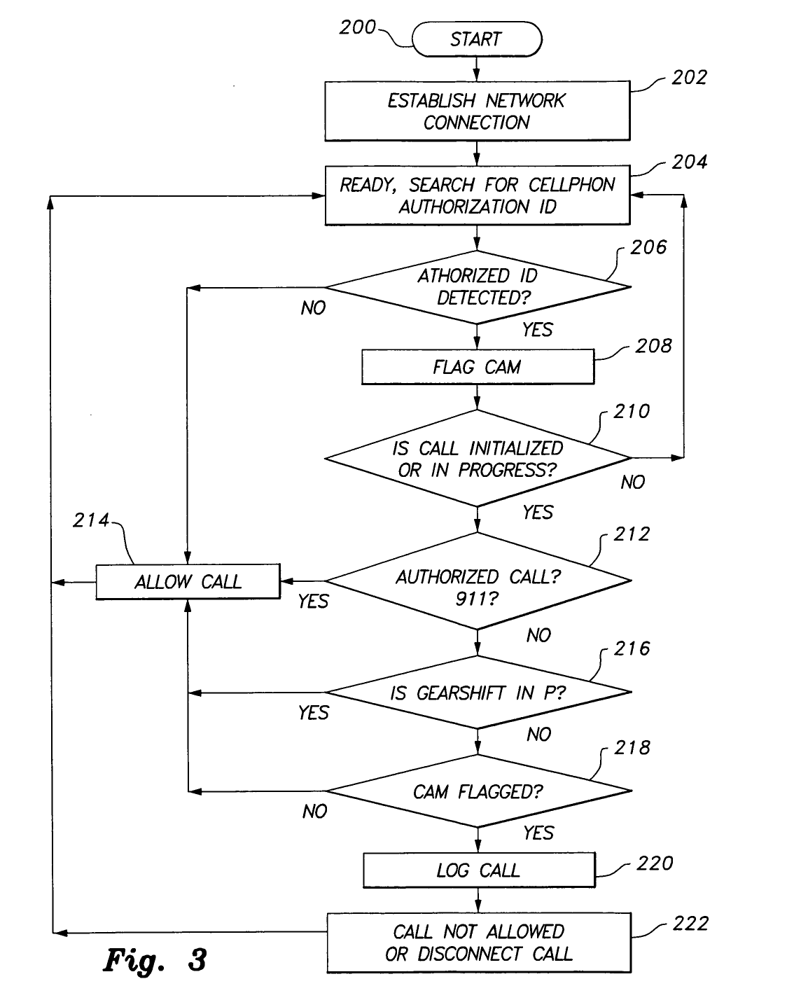

The ignition key 502 of FIG. 6 may also be used with system 10 of FIG. 1A. It should be understood that the key may be replaced by any suitable device including an identification tag, such as a separate key fob. As shown in FIG. 3, the method is substantially similar, but with a separate authorization now being provided by the RFID tag (or the like) held in key 502. In FIG. 6, the key 502 was used by the authorized vehicle driver. However, such a key or other identifying device may also be provided to people who are authorized to override the communication blocking system, such as police officers and other emergency workers.

Upon initiation at step 200, the system searches for a network connection (step 202), as in the above. The authorized key or tag holder approaches the vehicle, reaching the identification searching zone 204. The universal call authorization code or ID from the key is detected at step 206, which, in turn, directs the flow to allow the call at step 214. Other drivers who do not have the authorized key or tag pass to step 10, where CAM 16 flags the process. This flag signal is momentarily active (or not “latched”; i.e., the flag condition is active only in when CAM 16 is detecting a proximity signal, as above). At this point, cellular phone C still can be used (step 214) or may be in the process of placing a call (determination at step 210). A similar call authorization process also occurs at step 212. As soon as the gearshift is out of park or neutral (step 216), its Bluetooth or other wireless transmitter sends a signal to trigger the second condition of CAM 16 (step 218), with the CAM 16 then checking the flag and disabling the cellular telephone's transceiver or otherwise not processing the call. This process prevents the passenger from initiating a call and then handing the phone over to the driver, for example. If this scenario occurs, the call in progress will be disconnected as soon as the phone enters the read zone of the driver's seat RFID tag. Next, the system captures and logs (at 220) any call attempted by the driver (for law enforcement purposes or the like).

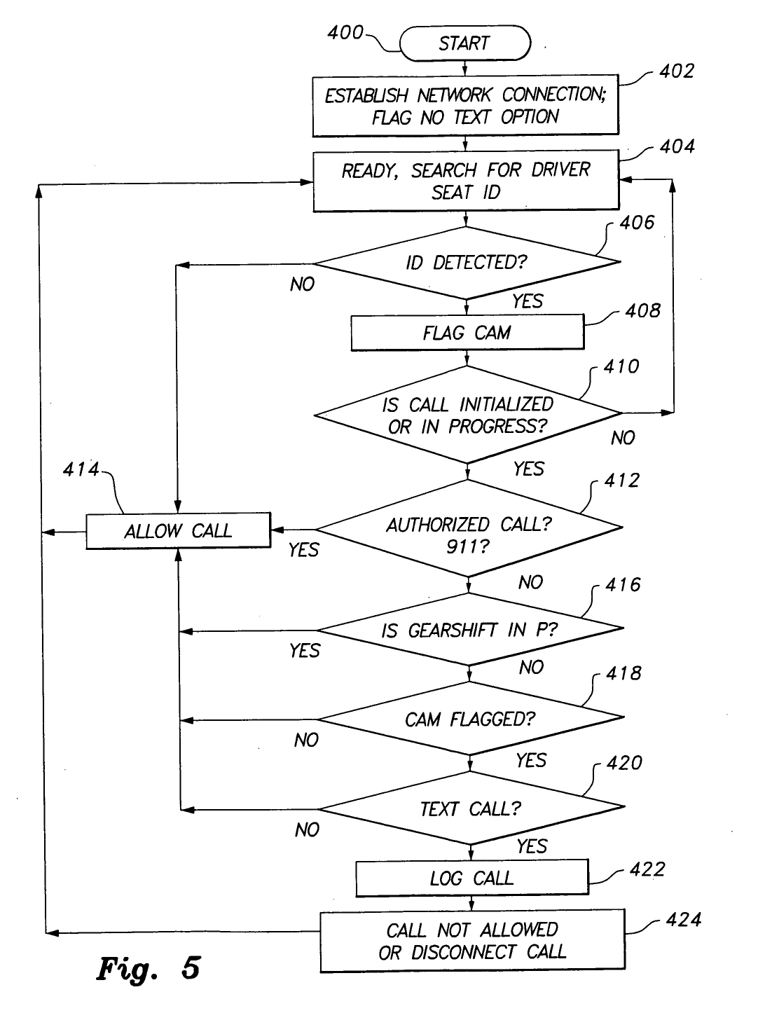

FIG. 5 illustrates another alternative embodiment, allowing for the deactivation of select functions of the cellular telephone phone C, such as only text messaging, while still allowing a phone calling option for the user. Since placing a phone call requires a different set of operations than text messaging, it is possible for the cellular telephone to differentiate which function is being used and, thus, only inhibit one or more functions, if so desired or necessary.

Upon initiation at step 400, the cellular telephone C searches for the cellular network at step 402 and, at this point, any state-mandated laws regarding device operation, for example, may be input to the CAM 16. For example, a particular state may ban only text messaging while driving, thus text messaging operations are flagged at step 402. The cellular telephone is otherwise ready to be used.

CAM 16 searches for the driver's seat identification tag, as above, and if the tag signal is not found (step 406), the driver can place a phone call or generate a text message (step 414). If the tag signal is detected, CAM 16 is enabled, as described in the previous embodiments. The CAM 16 now searches for an ongoing call or a new call at step 410. If none exists, the process loops back to step 404; otherwise, flow passes to decision step 412. If a call does exist or is initiated, the system verifies the call and allows it if the call is an authorized call (such as an emergency call, determined at step 412). If the call is not authorized, then the determination of gearshift position is made at step 416. If the gearshift is in park or neutral, the transmitted signal allows the call (step 414) regardless of whether the call is a text message or a voice telephone call. If the gearshift is not in park or neutral, the CAM 16 is actuated, and if the condition is flagged (step 418), the CAM 16 will check to determine if the call is a text message (step 420). If not a text message, in this particular example, the call will be allowed. If a text message is being generated, the flow passes to step 422, which logs the attempt, and the call is disallowed or disconnected at step 424.

It should be understood that any suitable system or method for determining the position of the cellular telephone C may be utilized in the above embodiments. For example, rather than the single sensor and single tag illustrated in FIG. 1A, multiple sensors and/or multiple tags may be used to obtain a triangulated (and, thus, more precise) location. Alternatively, transmitters of multiple telephones or other devices may be used to generate such a triangulated position.

It is to be understood that the present invention is not limited to the embodiments described above, but encompasses any and all embodiments within the scope of the following claims.

We claim:

1. A vehicle safety system, comprising:
means for determining proximity between a cellular telephone and a driver's seat of a vehicle;
means for selectively deactivating the cellular telephone; and
means for determining a gear state of the vehicle, the means for determining the gear state of the vehicle and the means for determining proximity between the cellular telephone and the driver's seat being in communication with the means for selectively deactivating the cellular telephone;
the means for selectively deactivating the telephone disabling the cellular telephone from making a telephone call when the cellular telephone is located within a pre-set range from the driver's seat of the vehicle and the gear state of the vehicle is such that the vehicle may be driven under power.

2. The vehicle safety system as recited in claim 1, wherein said means for determining proximity comprises:
an identification tag mounted on the driver's seat; and
a sensor for sensing the identification tag, the sensor being in communication with said means for selectively deactivating the cellular telephone.

3. The vehicle safety system as recited in claim 2, wherein the identification tag is an RFID tag and the sensor is a radio frequency receiver.

4. The vehicle safety system as recited in claim 2, wherein said means for determining the gear state of the vehicle comprises:
a position sensor mounted to a gearshift of the vehicle for determining the position of the gearshift and the corresponding gear state associated therewith;
a transmitter in communication with the position sensor for transmitting the position of the gear shift; and
a receiver in communication with said means for selectively deactivating the cellular telephone, the receiver being for receiving the transmitted position of the gearshift.

5. A vehicle safety system, comprising:
means for transmitting a cellular telephone jamming signal;
means for selectively actuating an engine of the vehicle; and
means for determining a state of a driver's seatbelt of the vehicle, the means for determining the state of the driver's seatbelt of the vehicle and the means for transmitting the cellular telephone jamming signal being in communication with the means for selectively actuating the engine;
the means for selectively actuating the engine permitting the vehicle to be driven under power only upon detection of proper fastening of the driver's seatbelt, the cellular telephone jamming signal being transmitted so long as the engine is actuated to prevent cellular telephone use while driving.

6. The vehicle safety system as recited in claim 5, wherein said means for determining the state of the driver's seatbelt comprises:
an identification tag mounted on the seatbelt; and
a sensor for sensing proximity of the identification tag.

7. The vehicle safety system as recited in claim 6, wherein the identification tag is an RFID tag and the sensor is a radio frequency receiver.

8. The vehicle safety system as recited in claim 6, wherein the identification tag is a magnetic tag and the sensor is a magnetic sensor.

9. A method of providing vehicle safety, comprising the steps of:
determining proximity between a cellular telephone and a driver's seat of a vehicle;
determining gear state of the vehicle; and
selectively deactivating the cellular telephone when the cellular telephone is located within a pre-set range from the driver's seat of the vehicle and the gear state of the vehicle is such that the vehicle may be driven under power.

10. The method of providing vehicle safety as recited in claim 9, wherein the step of determining the proximity between the cellular telephone and the driver's seat of the vehicle includes receiving an identification signal from an identification tag mounted on the driver's seat.

11. The method of providing vehicle safety as recited in claim 10, wherein the step of determining the gear state of the vehicle comprises:
measuring a position of a gearshift of the vehicle;
transmitting a gear shift position signal; and
receiving the gearshift position signal.

12. The method of providing vehicle safety as recited in claim 11, further comprising the step of determining if the cellular telephone is in use.

13. The method of providing vehicle safety as recited in claim 12, further comprising the step of determining if an authorized call is being placed on the cellular telephone.

14. The method of providing vehicle safety as recited in claim 13, further comprising the step of generating an override signal to maintain the cellular telephone in an activated state if a call on the cellular telephone is authorized.

15. The method of providing vehicle safety as recited in claim 14, further comprising the step of logging the call placed on the cellular telephone.
